(19) United States
(12) Patent Application Publication
(10) Pub. No.: US 2003/0200104 A1
(43) Pub. Date: Oct. 23, 2003

(54) Value resolution process

(76) Inventors: William B. Heming, Peoria, IL (US); Willibald G. Berlinger, Peoria, IL (US)

Correspondence Address: CATERPILLAR INC., 100 N.E. ADAMS STREET, PATENT DEPT., PEORIA, IL, 616296490

(21) Appl. No.: 10/126,123

(22) Filed: Apr. 19, 2002

(51) Int. Cl. G06F 17/60

(52) U.S. Cl. 705/1

(57) ABSTRACT

For property that does not have an established value, parties can have difficulty in agreeing on value. In some cases, the transaction costs of the parties can exceed the value of the rights in the property that are at issue. This deters the conclusion of such transactions on an economical basis. Such issues might arise, for example, with respect to transactions involving the transfer of rights to intangible or intellectual property. Provided are systems, steps and methods that enable the resolution of value by taking different risks of valuation into account. In one embodiment, property is given an assigned value based upon calculated actual value. In another, a property may not be subject to the value resolution methodology where its value does not fit one or more pre-set parameters. The systems, steps and methods lend themselves to computer implementation. They may find particular usefulness in web based systems where a community of parties may, in effect, trade properties through a number of unrelated individual transactions.

### TECHNICAL FIELD

The invention relates to systems, processes and methods for exchanging rights in property, and more particularly to resolving value of property that does not have an established value.

### BACKGROUND

Property that is not easily valued often means that the market for exchanging rights in such property suffers. Because of the lack of established prices, it is not always straightforward to conduct business in such property and the time and cost of related transactions can be high. This is in contrast to confidence found in readily dealing with products or services, such as automobiles, some software programs, and consumer goods, which have retail and/or wholesale prices.

Modern business finds ever increasing value in such property that is not easily valued, particularly intangible property. These intangibles include intellectual property and intellectual capital, as well as others. Intellectual property is often defined to mean patents, copyrights, trademarks, know-how and trade secrets, but in this context may also include the ideas, methods or technology that are often represented by those legally defined properties.

Intellectual capital is thought of as the content of the minds of employees, that is, the capability of a business to innovate and act. In fact, the value of intangibles can now be seen to represent more value in the market capitalization of companies than hard assets, such as plant and equipment.

Property, such as intangibles, is not easily valued because of the many issues that affect price. For example, the scope of what a patent covers or protects is subject to interpretation and can even change through legislation or court decision. Whether or not a patent can be designed around, or a trade secret can be reverse engineered, affects what one party will pay, knowing that another party may not have to pay where the design around or reverse engineering is successful. And different parties may desire different rights to use an intangible property (which can, in fact, be used by more than one party), making valuation in each case subject to different facts that will change the value to each party.

Businesses and individuals have tried to unlock the full potential of intangibles, particularly intellectual property, by modern management practices, licensing, and selective enforcement against those using the property without permission. The dilemma still remains that agreeing on the potential and value of such property, and licensing it to or enforcing it against others can be a long and complicated process. Experience shows that it can take 12-24 months to identify a “buyer” and negotiate a license transaction. Enforcement in the courts can take much longer. Perhaps as problematic are the numerous smaller issues for which it is not economical to pursue litigation or engage in protracted negotiation. Many owners of intellectual property confront these smaller issues with some frequency and can spend more money to argue back and forth than is represented by the value of settling the issue.

One of the promising avenues of matching “buyers” and “sellers” of intellectual property, as well as other intangibles and related services or products, is the world wide web. For example, there are several internet or web based market places where technology and patents are listed for sale or license. These market places hope to leverage the enormous potential of a well-known web site to display to the world. The advantages are high visibility and easy access, but it still remains a challenge to attract real “buyers” and settle on terms for license.

In order to bring “buyers” and “sellers” closer together more quickly, these internet sites have experimented with different techniques.

Foremost is the way information is catalogued or featured to enable “buyers” to identify promising solutions among posted technologies. Additionally, some attempt has been made to pre-value the offered intellectual property to close the gap between how “buyers” and “sellers” perceive value or provide improved “buyer” receptivity. This involves appraising a property without reference to the facts of a specific buyer-seller transaction. Even with all of this, resolving value and providing an active market place is very difficult. Transactions remain mostly singular to the parties involved and do not take advantage of the economies available by inter-linking deals and clients in an available market place.

The present invention is directed to solving one or more of the problems set forth above.

### SUMMARY OF THE INVENTION

In one aspect of the present invention, a method is provided for resolving the value of a property. Steps of the method include establishing a methodology for valuation and determining an actual value for the property.

Further steps are comparing actual value to value increments and assigning one of the value increments to the property.

In another aspect of the present invention, another method is provided for resolving the value of property. Steps include establishing a methodology for valuation and determining a property value. A further step is comparing the value to a target value and resolving the value of the property according to a predetermined relationship with the target value.

In yet another aspect of the present invention, a method is provided for resolving the value of property. Steps involve establishing a valuation methodology and determining a value of the property. A further step is comparing the value to a plurality of classes, each having a maximum value and minimum value. A still further step is resolving the value of the property based on the class for which value falls between that class' maximum and minimum values.

In still another aspect of the present invention, a method is provided for resolving the value of property. Steps include establishing a valuation methodology, setting value increments and a target value. Further steps involve determining an actual value for the property and comparing the actual value to the target value. Additional steps involve comparing the actual value to specific value increments and assigning one of the value increments based upon a determined relationship for assigning them.

In still one more aspect of the present invention, a barter based system is provided for exchanging property rights that includes automated valuation and determining tools. The valuation tool determines actual value for property rights. The determining tool determines an assigned value from a plurality of assigned values that have actual values exclusive to them. A bank is provided for recording a debit and a credit at least partly in trade credits from determination of the assigned value.

In yet one more aspect of the present invention, a barter based system is provided for exchanging property rights between parties of the system.

The system includes an automated valuation tool configured to determine the value of rights in the property. An automated determining tool is configured to calculate consideration to be transferable by another member for the rights. A bank is provided in which at least one member account is modified to reflect an amount at least partly in trade credits associated with the consideration.

In still another aspect of the present invention, a system for exchanging rights in property is provided. The system includes client systems, a listing system, a value resolution system and a banking system. The listing system has processes for listing and providing those listings to client servers.

The listing system further has a process for receiving indications of interest in the listings. The value resolution system has processes for receiving data pertaining to a property from a client system, determining actual value based upon the data and assigning a value based upon the actual value. A further process establishes a consideration amount for the property associated with the actual value. The banking system has processes for receiving and executing instructions to debit and credit currency for transactions for listings and for the consideration amount. A further process is provided for calculating and assessing a commission on a transaction. Processors are provided for executing the processes/

### BRIEF DESCRIPTION OF THE DRAWINGS

FIG. 1 illustrates an exemplary system environment in which systems, methods and steps consistent with the principles of the present invention may be implemented;

FIG. 2 illustrates a block diagram of an exemplary listing system consistent with certain principles consistent with principles related to the present invention;

FIG. 3 illustrates a block diagram of an exemplary value resolution system consistent with certain principles consistent with principles related to the present invention;

FIG. 3A illustrates a flowchart of an exemplary method for value resolution consistent with certain principles consistent with principles related to the present invention;

FIG. 4 illustrates a block diagram of an exemplary banking system consistent with certain principles consistent with principles related to the present invention; and

FIG. 4A illustrates a flowchart of an exemplary method for bank operation consistent with certain principles consistent with principles related to the present invention.

### DETAILED DESCRIPTION

Reference will now be made in detail to the exemplary aspects of the invention, which are illustrated in the accompanying drawings.

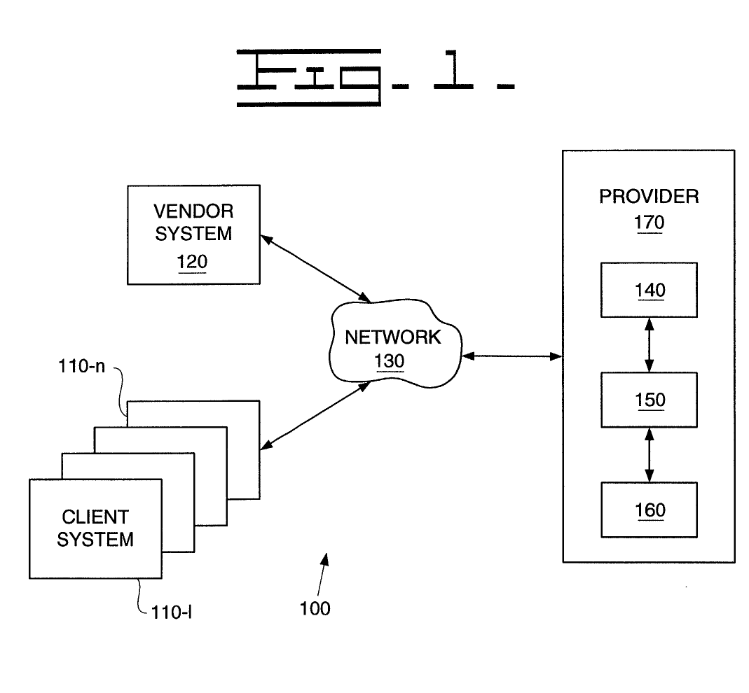

FIG. 1 illustrates an exemplary “market place”, such as system 100, in which features and principles consistent with the systems, processes and methods of the present invention may be implemented. As shown, the exemplary market place is computer implemented. It does not need to be so implemented or practiced, the present invention being capable of applications without such tools. The system environment may include a plurality of client systems 110-1 to 110-n (also sometimes referred to as client system or systems 110 for convenience), vendor systems 120 (only one shown), network 130, a listing system 140, a value resolution system 150, a banking system 160 and provider 170. One skilled in the art will realize that any number of these elements may be implemented, or may be combined, within the environment without departing from the scope of the present invention. The invention will further be described in the context of a web-based environment, although it should be understood that this is not necessary to carry out the invention. It should also be understood that the broad concept of market place as described is not the necessary environment for practicing principles of the invention. The invention may be practiced between individual parties or in other environments.

Each client system 110 may be a desktop computer, workstation, laptop, personal digital assistant, and any other computer system known in the art. For example, a representative client system 110 may include a processor, associated memory, and numerous other elements and functions available in computer systems. These elements may include input/output devices, such as a keyboard, mouse and display, although these input means may take other forms. Also, included in client 110 and vendor 120 systems may be a network interface and a web browser application stored within a local memory for communicating with network 130. Client systems 110 may also be associated with handheld and/or portable computing devices, such as the Palm Pilot from Palm T. A client as farther discussed below may operate a client system 110 to perform functions consistent with features related to the present invention. A vendor may similarly operate a vendor system 120.

Network 130 interconnects client 110 and vendor 120 systems, as well as other systems such as the listing 140, value resolution 150 and banking 160 systems. Network 130 may include one or more communication networks and servers, including the internet or another network that may support web-based processing. Further, network 130 may include wireline and/or wireless based networks. Each system 140, 150, 160 maybe a computer system (or part of one system) that provides information to a requesting entity through network 130. The systems 140, 150, 160 may include a desktop computer, workstation, mainframe, or any other server system known in the art. Further, systems 140, 150, 160 may include and/or be connected to one or more memory devices, such as databases.

The systems, processes and methods to be discussed, as illustrated by the examples and embodiments, facilitate a market place for properties, plus, where desired, products and/or services. In particular, the systems, processes and methods will be described with respect to properties and associated rights that do not already have a value or price for the purposes for which related transactions may occur. In other words, a property or rights associated with it do not have a fixed, established or familiar price, even though a price or value may be determined by known or accepted valuation or appraisal methods. Automobiles, computers, consumer goods, engineering services and even some software, for example, usually have established wholesale and/or retail prices and would not typically be property as defined herein. Of course, there may be circumstances where goods or services with established prices may otherwise be grouped or desired so that price is not necessarily ascertainable. One may also fix a price for a property that does not otherwise have such a price. The price so fixed may be arbitrary, based upon experience or otherwise. In any event, if a value is already available or agreed to, aspects of the present invention (in particular, value resolution as will become apparent) would not be needed for the purposes of a contemplated property related transaction.

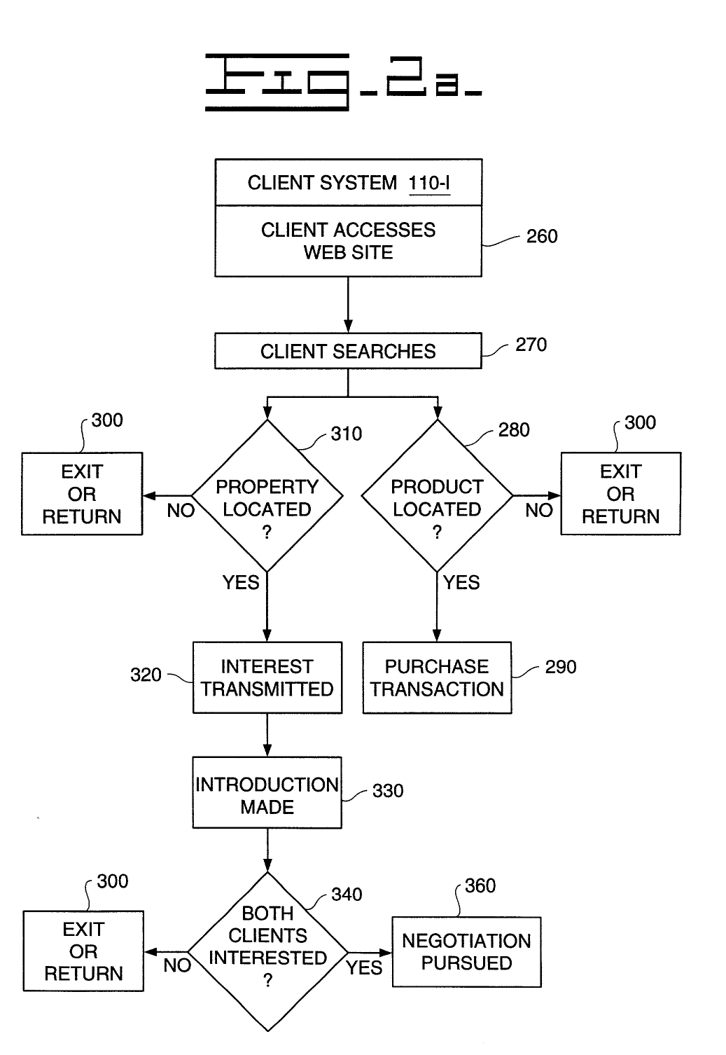

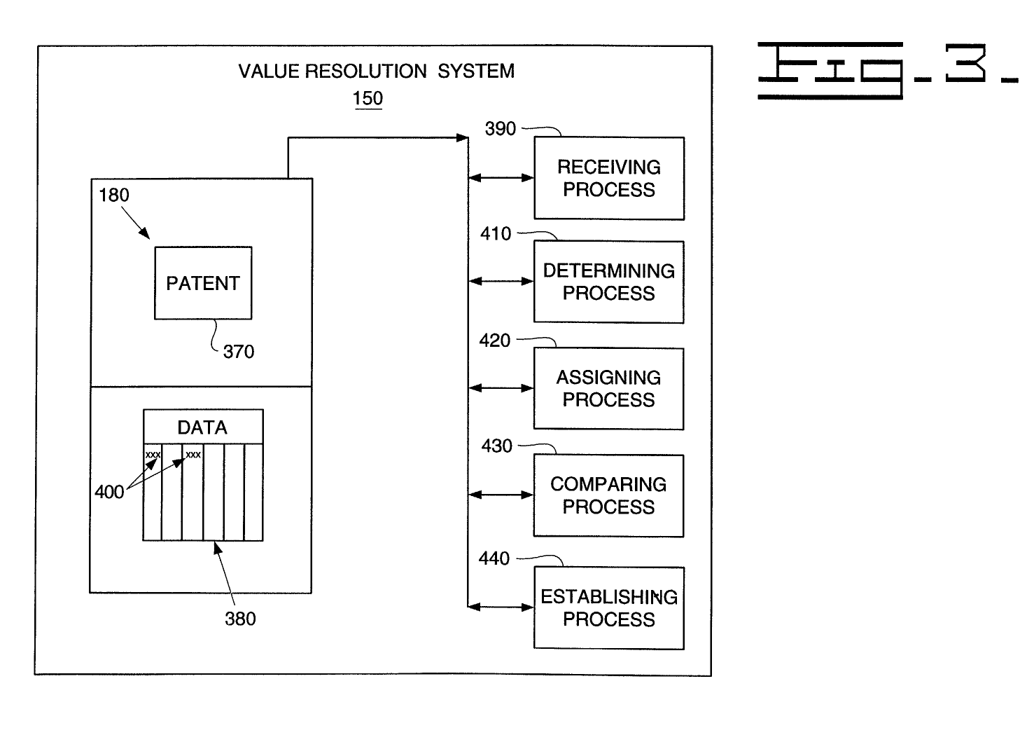

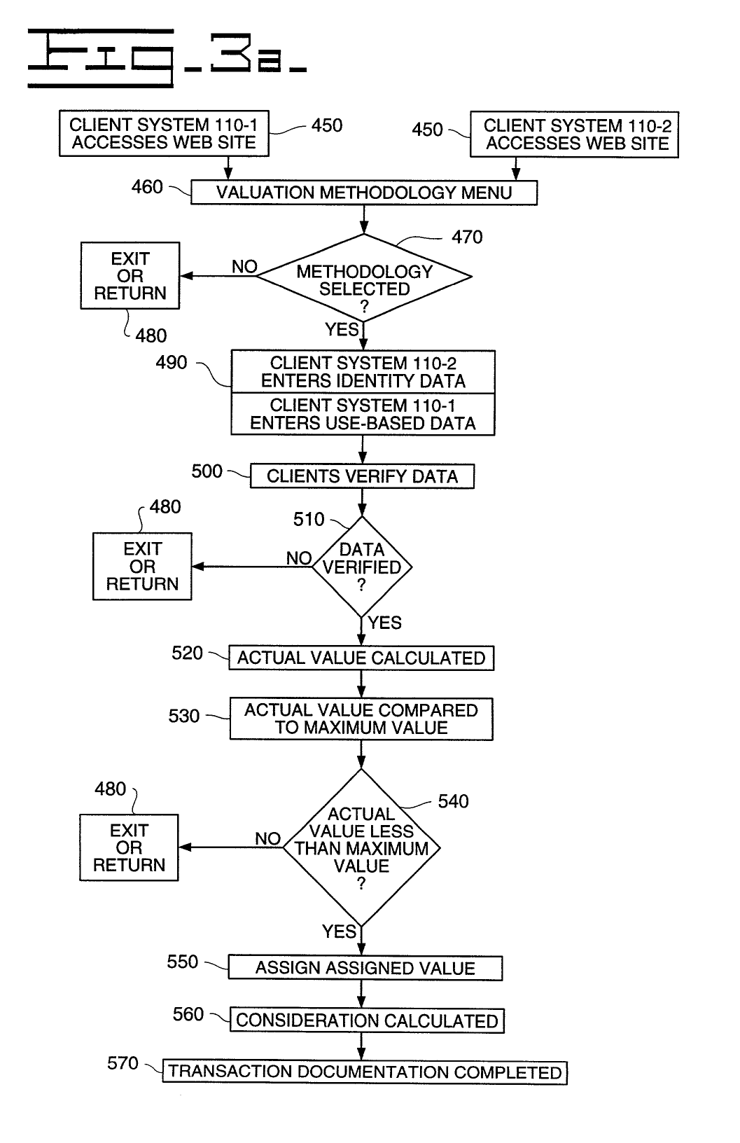

Property as defined for purposes of the present invention is represented in FIG. 2 by properties 180-1 to 180-n. In FIG. 3, the property is represented by a single property 180. For convenience, the following discussion may refer to just a property 180.

In one embodiment, property 180 is intangible property, such as intellectual property. Intellectual property is often used to refer to a class of assets that have a legally defined status, such as a patent, trademark, copyright, k now-how or trade secret. It may also include technology, methods and ideas for the present discussion. In another embodiment, property 180 could include a product or service or other property that has an understood or established price.

For example, a transaction involving a trade secret for welding might also involve transfer of a commercially available machine that can perform the secret welding process. Thus, the “total” property 180 will still have the characteristic of value that is not established, because of the trade secret aspect. For convenience, examples of property 180 will be made particularly with respect to intellectual property, and particularly patents, but it is not intended to so limit the present invention. Other examples of property 180 might include rights in real estate, unique services, or antiques. It is also not intended to limit a reference to property 180 to mean a single property. For example, property 180 can be one or more patents or copyrights.

Products and services may be any type of offering that clients may wish to consider for purchase or other type of transaction. Typically, they will have some relationship to the specialized purpose or subject matter of the market place itself. In the example of intellectual property, such products and services may include software and literature for intellectual asset management and engineering consulting services.

In the example of FIG. 1, the client system 110 is the interactive point for a party or client into the market place. A client may be from the public or may be a member that has specific status or some exclusivity in the market place, such as through payment of fees or a selection process for joining. A plurality (at least two) of clients are necessary and preferably a relatively significant number are desirable. The market place is maintained by provider 170. Provider 170 may be only a computer system administrator or preferably a party that maintains the market place through expertise in the classes of and/or transactions in properties, products and/or services affected. Provider 170 and vendors may also act as clients. Other administrators may also perform roles in the system 100.

Thus, the market place is set to expedite transactions related to property 180 and exchange of goods and services. Steps are provided, and clients access the exemplary systems 140, 150, 160, for these purposes. As illustrated on FIG. 2, the listing system 140 includes a process 200 for listing properties, as well as services 210-1 to 210-n and products 220-1 to 220-n. The listing system 140 further has the capability to provide those listings to clients systems 110, vendor systems 120 and/or others. For convenience, reference will typically be made simply to a service 210 or product 220. Alternatively, the listings 230 can actually be on the vendor system 120, or even client systems 110, where the provider 170 simply provides a storefront through the system 100. This may be more typical for products and services than for properties 180. For example, the storefront may have a catalogue of available properties, products and/or services. A client may select and configure any combination of the properties, products or services. Once the desired selection is made, the client may make further use of the market place as described.

The listing system 140 will further provide a process 240 for receiving indications of interest, including offers, in particular properties 180. The same may be the case for the products 220 and services 210. A client may initiate and conclude a purchase or other transaction over the network 130, in well known manners, by a process 250 for concluding the transaction.

FIG. 2A shows a flowchart of an exemplary method for listing and which may be implemented through the use of listing system 140 or other tool or system. The example of use through the listing system 140 will be used. As shown, the listing process 200 may begin when a client located at representative client system 110-1 accesses a web site operated by provider 170 (Step 260) and locates the listing system 140. The client may access the web site directly from client system 110-1 and network 130. Alternatively, a client may access the web site through a branded web site provided by a vendor system 120. Although the method illustrated in FIG. 2A is described below with reference to a client accessing listing system 140 through client system 110-1 and network 130, one skilled in the art would realize that the client may access listing system 140 using a number of other different techniques.

In one aspect of the invention, once a client accesses the web site provided by provider 170, one or more web pages may be provided and displayed to the client through a browser executing at client system 110-1. The web page may provide, among other information, an option that allows a client to search (Step 270) in a variety of ways for property 180, products 220, and/or services 210 listed or otherwise available. Such web pages and searching techniques are well known.

The illustrated method demonstrates two different possibilities leading toward a transaction over the web site. In the case of property 180, the search conducted at Step 270 may be conducted in a variety of ways that are influenced by the intangible nature of property 180. For example, searching might be conducted by subject matter, technical problem needing a solution patent number, or a request broadcast to others. Searching for products 220 and services 210 might be done on a more conventional basis, such as by seller, name or catalogue number. However, the examples are not meant to exclude one type of searching or another for any particular situation.

Assuming that a product 220 (or service 210) is being searched for, if the correct product is located at a Step 280 (Yes), then a purchase transaction (Step 290) can be concluded. A purchase transaction might be concluded in any known way, including transmittal through client system 110-1 of purchaser, credit card and shipping information. If a product is not located at Step 280 (No), then the client 110-1 may choose to exit or return for another search (Step 300).

In the case of a property 180, if a property is located (Yes) at a Step 310, the client 110-1 may transmit its interest (Step 320) over the network 130. Interest may be shown by asking provider 170 to forward an introduction to the listing party, by submitting a bid or request directly to the listing party for rights to the property 180, or other means of expressing a desire to obtain the property 180 or rights therein. These activities could be prompted through a menu that permits different options to be selected at Step 320. In one example, the bid option might provide for data to be input by the requesting party to establish a bid amount. Data might be input against the listing party's requirements and a calculation made as to price. In another example, depending on the selection made, a communication of interest may be automatically submitted, such as by e-mail. Assuming for illustration purposes that client system 110-1 desires an introduction, the introduction is then made (Step 330). If both clients are interested at Step 340 (Yes), then a negotiation or other resolution (Step 360) may be pursued for the clients to conclude a transaction. This may be done either through the network 130 or by other means (such as face to face negotiations). In one embodiment, the negotiation process may use standardized factors that permit the parties to resolve issues quickly. If a property is not located in the first instance (Step 310 No), or both parties are not interested, or a property 180 proves not to be as needed (Step 340 No), the client system 110-1 may exit or return for additional searching (Step 300). The present example suggests that the parties will engage in some negotiation other than a straightforward exchange of consideration, because transactions for property 180 are typically based on the particular facts of each situation.

Referring to FIG. 3, the value resolution system 150 is illustrated in a block diagram. In overview, it includes processes for addressing the issues of value for property 180. In some instances, clients 110 may be interested in moving from the listing system 140 or other such activity to value resolution, as where at Step 360 in FIG. 2A they are interested in resolving value to conclude the transaction. In other instances the property 180 addressed by value resolution system 150 will not be listed at all on the listing system 140. Thus, it is not intended to limit the invention to embodiments where the particular piece of property 180 has been or is listed in the listing system 140 or elsewhere in the market place and then addressed by the value resolution system 150.

System 150 has the capability to determine actual value for property 180 by client interaction, directly or indirectly. As such, the type of property 180, as well as attributes of the property 180, will typically be identified within or by system 150. Identity by whatever means will be particularly appropriate where different types of property may be addressed by the value resolution system 150, or rights in similar or different properties so addressed may vary. For example, value resolution system 150 could be dedicated to resolving the value only with respect to patents or another specific type of property, or sub types of specific properties, or may act on different types or categories of property. Depending on the capability of the system to handle different property, then, more or less identification of a property 180 subjected to value resolution may be needed. For purposes of the present discussion, the use of system 150 is illustrated in FIG. 3 with respect to a particular piece of property 180 or patent 370.

For clarification, while reference may be made to property 180, particularly with respect to value resolution, it should be understood that this is synonymous with reference to rights in property 180. Thus, value resolution may in some cases pertain to all rights in a property (such as in a complete sale of all right, title and interest). In other cases, it may pertain to less than all rights. For example, it is common to license less than all rights in intangible property, especially in intellectual property. Clients may desire to obtain, or only be offered, a right or license to use patent 370 only in a certain line of business, only in a certain geographic area, on a non-exclusive basis, or subject to other limitations well known to those who make such transactions. In the case of a license, therefore, value resolution may only be applied in valuing the limited license rights and not the full value of the property represented by all rights.

Clients will agree on a parameter or parameters 380 (such as above described) important to defining the type of property and the scope or bounds of the rights (for example, non-exclusive or exclusive) to be exchanged for the property at issue. And as is well known, the scope of rights conferred will affect transaction price. While parameters 380 may define the property and scope of rights, they may also embody fields (FIG. 3) needing to be filled in with more data to calculate value. For example, the numbers and prices of a product to be sold under license are commonly used to determine the royalty payable for license rights to a patent, which is the value of the property 180 for such purposes. Parameters 380 will vary depending on the property 180 being considered and the methodology of valuation used.

Value resolution system 150 exemplifies a step of establishing a methodology for valuation of (rights in) the property 180 applicable to the goals of the clients 110. The valuation methodology is used to determine a value for property 180 as further discussed below. In the illustration of FIG. 3, the method of valuation is assumed to be inherent within system 150 and thus selected when system 150 is used. In effect, clients choose the methodology by using the system 150. In another embodiment to be discussed (FIG. 3A), the clients may have the opportunity to select the methodology from among choices. This may be done by simple agreement between them, at which point the methodology is selected for use by whatever means may be provided for them to do so. In other embodiments, a methodology may be recommended to them. Selection may also start with the answering of questions by one or more clients 110. Through such answers (such as with information that might be identified with parameters 380), the clients or a third party such as provider 170 might select the method. In another embodiment, the system 150 itself or other method followed may select or recommend the appropriate method through predetermined relationships between answers and characteristics of the available valuation methods. Where a methodology is to be recommended, a step will be provided to receive a decision to one of accept or reject the recommendation. In still another embodiment, an iterative process might be applied where a first assessment or valuation methodology is selected and used. System 150 or other method might then offer one or more valuation methodologies based upon this preliminary assessment or value. This approach can take advantage of narrowing the choices for valuation, such as by selecting more sophisticated models for higher value properties from cruder initial estimates of value.

The value resolution system 150 of FIG. 3 has a process 390 for receiving information or data 400 from a client system 110, particularly that which pertains to a particular property 180. This illustrates the step of assigning through the valuation methodology an agreed value for at least one parameter 380 associated with a specific property 180. A further step of determining the actual value of rights to the property by exercising the valuation methodology against the desired data for a parameter or parameters 380 takes place. The system 150 exemplifies this step or process through another process 410 for determining the actual value of the particular property 180 or patent 370 based upon the data 400.

Data 400 (also referred to herein as use-based data) refers generally to any data necessary to determine value. In a typical situation, the client (or clients) that will grant or sell rights (for example, the licensor) and the client (or clients) that will take rights (for example, the licensee) will agree on the data 400 to be used in the process for determining value. This step of providing data 400 or input into the valuation methodology (discussed below in detail) can be done by the potential licensee or licensor through a client system or by another party. The source is not as significant as assuring that agreed or acceptable data 400, including values for any parameters 380, are input.

In another example, it is contemplated that certain use-based data 400 may be confidential to a potential licensee. For example, product sales volume and profitability are two parameters on which license price or royalties are often based. Without use of this information, therefore, a calculation of value may not fit the need of one or both clients and deter a quick resolution of value. Yet, licensees are reluctant to share this information, especially with competitors. The value resolution system 150, particularly in a web based format, permits this information to be submitted by the client licensee directly to the receiving process 390. Used, as necessary, with other data 400 that both client licensee and licensor can see, an actual value can still be calculated without disclosure of the confidential data. Of course, a client licensor may take issue with a value calculated where that licensor does not have full appreciation of all data submitted by the prospective licensee. In one embodiment, confidential data could be directly entered into value resolution system 150 without review. In another embodiment, a neutral third party (including the provider 170) might review the appropriateness of the data. In the subsequent description of the present invention, it will become apparent that the capability of quickly resolving certain disputes or other value based issues between clients may outweigh this issue.

Reference to actual value is not meant to convey that an exact value will be or needs to be calculated. By its nature, property 180 is not typically capable of precise determination of value. A large number of legal, economic, market and application related factors may influence value at any given time. Because there are often different methods for valuing a type of property 180, and each may have different levels of precision, selection will depend on the needs of the parties. Actual value, therefore, is simply meant to connote a determination that represents the value of the property as between the parties involved as calculated by the chosen valuation methodology. Further, there may be more than one value determined in a particular value resolution, each of which may thought of as an actual value.

Examples of methods of valuation, particularly of intellectual property, include the income method, market method and technology factor method. The income method attempts to determine the present value of the income that may be generated over time through the use of a property. This method recognizes that the person granting the right to use a property should share in this income. The market approach uses the value of comparable transactions for the same or similar properties. The technology factor method is a hybrid of the income and market methods. These valuation methodologies and others are well known to valuation professionals. See, for example, Article 9-801-192, Dec. 8, 2000, of the Harvard Business School entitled “Intellectual Asset Valuation”. Volume XXXVI No. 3, September 2001 of les Nouvelles, the journal of the Licensing Executives Society, also discusses valuation practices in two articles: “Selection and Application of Intellectual Property Valuation Methods In Portfolio Management and Value Extraction” at page 77 and “Valuing Intangibles? Consider the Technology Factor Method” at page 87.

The different approaches and attributes of different valuation methods may lend them to usefulness in particular circumstances for purposes of the present invention. Advantages of one over another may relate to type and quantity of information required for input, levels of accuracy or sophistication, confidence of the clients through experience or reputation, or degrees of automation such as for computer implemented applications. Most methods of valuation determine value in terms of a currency amount, and often a full value amount. However, value resolution as contemplated by the present invention can accommodate valuations that provide other results, as will be discussed.

The amount of detail comprising data 400 is another variable that affects the capability of the system to arrive at an actual value. Of course, different valuation methods may require more or less data. The data to be input, and the type of valuation process, will determine confidence in the process 410 among clients. However, it is contemplated by the present invention system that simplified valuation processes may be used to achieve beneficial results as will be explained.

In one embodiment, a step of assigning the property 180 to one or more predetermined value increments or assigned values is illustrated. This may be done by a step of comparing an actual value for the property 180 to predetermined increments of value and then assigning one of the value increments. Typically, there would be at least two such value increments and the setting of such increments to represent assigned value of the property will usually occur in advance of valuation. In the embodiment of FIG. 3, process 420 is provided for assigning one of a plurality of predetermined assigned values or increments for the particular property 180. Thus, the described steps or process establish an assigned value of the property 180 based upon or with reference to actual value of the property 180. The purpose of assigned values is to provide a finite number of values among which clients will resolve the value for a particular property. Spread between assigned values does not need to be equal.

In other embodiments, beneficial steps may include setting a target value and comparing a determined value for the property 180 to the target value. The target value is used to determine how to deal with a particular property in the value resolution process. Comparing a property value and target value will position the property in a relative sense for purposes of proceeding with value resolution. For example, in one embodiment, the target value may be a maximum value, the purpose of which is to limit the properties by value that will be subject to a particular value resolution. Based upon the step of comparing, the property 180 will be rejected as a candidate for value resolution if its determined actual value exceeds the maximum actual value. It will be accepted if the determined value is less than the maximum value. If the actual value equals the maximum actual value it may be accepted or rejected depending upon how the maximum value and comparing step is set. In any event, when used with assigned values, the previously described assigning process 420 will take place only where the actual value is within the chosen maximum value. In other embodiments, more than one target value may be used to position the property for value resolution among several possibilities to conduct the value resolution (an example to be discussed later).

Process 430 of the value resolution system 150 is illustrative of using a maximum actual value. It provides for determining whether the value of the property 180 in question is higher than the value resolution system 150 is contemplated to address. For example, clients or the provider 170 may determine that properties having “higher” value are best dealt with by more traditional methods or other processes. Additionally, if the contemplated value of a property 180 is initially misapprehended and submitted to the value resolution system 150, a higher than expected actual value may be calculated. Without a maximum value, the property 180 may then be given an assigned value that, even though the highest one set in the process 150, is not appropriate for purposes of value resolution. The maximum value or another target value or values may also be useful where a licensee is permitted to enter confidential data without review by another.

In another embodiment, actual value classes may be set instead of using just one maximum value. Each of the classes will have a minimum and maximum actual value (each a type of target value) and may have one or more of its own assigned values in some embodiments. Assigned values in the different classes do not have to be equal in number or have equal spreads between them. Different classes might be used to take advantage of different relationships with assigned values in a class or different valuation methods. In the step of comparing, then, the actual value for property 180 will be compared to the minimum and maximum actual values in each class. If the actual value of property 180 falls between the minimum and maximum for a class (or on or between those values depending on how chosen), that particular class would be applicable for value resolution purposes. The selection of the class then determines the assigned values used. If the actual value falls outside all classes, the property 180 would be rejected as a candidate for value resolution. In essence, if only a single maximum value is set as described in the prior paragraph, the parties have selected a single class with a value span between zero and the maximum value.

In the case of using value classes to take advantage of different valuation methods, one embodiment does so through the iterative process suggested earlier. For example, a simplified valuation methodology can be used to determine a preliminary value for property 180 to identify a likely value class in which the property 180 will fall. Alternatively, the parties could agree on a value class or have one selected for them by the provider 170, such as by an initial screening process. A valuation method associated with that class would then be used to determine actual value for value resolution purposes.

With a value established for use by the parties (that is, an assigned value or actual value, depending on embodiment), a process 440 or step is provided for establishing a consideration amount or exchange value for the particular property 180. The consideration or exchange value will be based upon the established value out of, for example, the value resolution process 150. This process 440 contemplates that the clients desire to conclude a transaction and exchange consideration, typically in the form of money or other currency, for the subject property rights.

In a typical case, the established value of property 180 and consideration may be identical and, thus, the processes 420, 440 are essentially one in the same. This will occur most obviously where values determined by the valuation methodologies represents the intended payment for the property rights, such as a lump sum amount for up-front payment. In other cases, a value may not be expressed in the currency intended for the transaction. For example, assigned or actual values may typically be expressed in a legal tender amount, such as United States dollars. However, the system 100, and particularly the value resolution aspects, may be barter based or at least partly barter based. If the transaction is to be concluded with trade credits utilizing concepts of barter, a conversion process would be necessary. It should be understood that the established value may itself be determined in trade credits, in which case a different consideration amount may or may not need to be determined for similar reasons above discussed. The same is true where the currencies of other countries might be involved and need to be converted. Also, there may be occasions where the established value is not expressed in currency (for example, a royalty percentage rate) or the desired expression of payment (for example, a monthly payment amount where a lump sum for payment in full is desired). In such cases, it may be desirable to use a conversion process to calculate the relevant currency (consideration) amount for settlement of the transaction.

In some embodiments, the steps and processes associated with actual value, maximum value and assigned values discussed above are each automated, such as through the computer implementation above described. By this, calculations and results are performed without or with limited human intervention following input of data as is well known in the art.

FIG. 3A shows a flow chart of an exemplary method for value resolution that may be implemented such as through use of the value resolution system 150. It utilizes both assigned values and a maximum value. As shown, value resolution may begin when a client located at client system 110-1 accesses a web site operated by provider 170 (Step 450) and locates the value resolution process 150. Typically, at least two clients may access the web site for value resolution, so Step 450 may also be conducted by another client (such as at client system 110-2) or clients. In some cases, the provider 170 or a vendor on a vendor system 120 may be involved as a client or in other capacities well. For convenience, the method will be discussed with respect to just two clients. The clients may access the web site directly from client systems 110-1, 110-2 through network 130. Alternatively, the clients may access the web site through a branded web site provided by a vendor system 120. One skilled in the art will realize that clients or others may access value resolution system 150 using a number of other different techniques.

In one aspect of the invention, once client systems 110-1, 110-2 access the web site, one or more web pages may be provided and displayed to the clients through a browser executing at client systems 110-1, 110-2. The web page may provide, among other things, information about the value resolution process itself, options to select, a location to input data, and data display. Such web pages and techniques providing menus and providing for input or displaying data are well known. In the exemplary method shown, clients are first provided a menu. From this, they can select how to proceed with value resolution. This option (Step 460) might provide them several selections for their value resolution needs, such as choices among different methodologies for their use or questions to answer to determine a recommended valuation methodology or make a preliminary assessment or valuation as earlier discussed. Step 460 may offer the further option to edit or provide an additional methodology. Further selections might be to set, or select from available choices, one or more assigned values, one or more target values and/or actual value classes (if not already an inherent part of a valuation methodology). It is contemplated that the parties will typically pick from pre-set choices offered that will fit their needs based upon self-assessment of the value resolution need at issue. In the case of a methodology recommended to the parties, the process will allow for rejecting or accepting the recommendation.

If a valuation methodology is selected at Step 470, then the clients can proceed. If a methodology is not selected, they can exit or return to the menu (Step 480). Typically, failure to mutually select a methodology will indicate that the value resolution process will not be used, so exit is contemplated.

Proceeding from Step 470, data may be input to enable actual value to be calculated. As previously discussed, the data can be input by one or both clients directly or through the help of a third party, such as provider 170.

Data may also be imported from a different portion of the system 100, such as from listing system 140, or another system. In this example, data is shown for input by both at Step 490. Client 110-2, the seller of rights, will input data identifying the property 180, so that the actual value will be associated with the particular property 180, such as patent 370. Client 110-1, the prospective purchaser of rights, will input data regarding desired use of the property 180. At Step 500, each client will then have the opportunity to verify the data input by the other, unless parts of it may be agreed to be confidential. In such event, the confidential portion will either not be reviewed or another, neutral party may intervene to verify it on a confidential basis. Verification permits both clients to review data from the perspective of what they contemplated in agreeing to use the value resolution method.

It should be noted that in some embodiments, some or all of the data may be entered earlier than Step 490, such as at Step 460, and used when needed at Step 490. This is because all or part of the data used in the calculation of value may be entered as part of the process to determine which value resolution method will be used. It is not important at which point data is introduced, so long as it is available in the appropriate form and at the right time to proceed with determining actual value.

If the data is satisfactorily verified (Step 510 Yes), the next step (Step 520) in which actual value is calculated will occur. If the data is not satisfactory to one or both, they will have the opportunity to exit or return (Step 480) for further discussions or other options to conclude their matter. Once Step 520 is completed with the calculation of actual value, this illustrated method proceeds with the step (Step 530) of comparing actual value to the maximum value. If the actual value is not less than the maximum value (Step 540), then the property 180 will have turned out to have a larger value than the clients expected. They will then be able to exercise Step 470 to exit or return. In doing so, they may choose to reselect parameters for value resolution and re-proceed or they may choose another process to resolve their matter. This step of comparing may be done automatically in response to the determination of actual value.

In one embodiment, an automated valuation tool is configured to determine the value of specific rights in the property 180. Thus, in response to input data for pre-selected parameters, the tool will automatically calculate value. It should be understood that knowing a valuation methodology, one skilled in the art will be able to provide the capability of such a tool through, for example, a software program capable of making such a calculation and reporting it. In other embodiments, valuation of specific rights may be done with human intervention, including with the assistance of a computer or other tool.

In this example of FIG. 3A, if the actual value of property 180 is less than the maximum value, the property will be assigned an assigned value (Step 550). In one embodiment, this is carried out by an automated determining tool configured to determine an assigned value associated with the value determined by the valuation tool or other method. This will be carried out in response to determination of actual value. In other embodiments, this may be done by hand or done with the assistance of computer or other tool. Determining an assigned value is typically carried out by selecting the assigned value from a plurality of possible assigned values. Each assigned value will have one or more values exclusive to that assigned value. It should be understood that understanding the process associated with reviewing values, such as actual values, and associating them with assigned values, one skilled in the art will be able to provide the capability of the automated tool through, for example, a software program capable of making such determinations.

At Step 560, consideration will be calculated. Preferably, the type of consideration will have been one of the things set at the outset (Step 460) and this Step 560 may proceed without intervention. A consideration amount in the currency or other form that is desired by the parties thus would be available based upon or from the value determined for the rights in the property. This will be an amount transferable by one client or member to another for rights in the property 180. In one embodiment, an automated determining tool is configured to calculate the consideration for the property as at Step 560 for purposes of the contemplated transaction. Thus, consideration will be automatically calculated in response to determination of the value on which the consideration is to be based. In other embodiments, this may be done with human intervention, including through direction of a computer or other tool to assist with the calculation. As will be further discussed, consideration may not be simply the amount of the assigned value, as for example conversions may take place or commissions may be taken. It should be understood that knowing the specifications for determining consideration, one skilled in the art would be able to provide the capability of the automated tool through, for example, a software program capable of making such calculations and reporting them.

In another embodiment, it is contemplated that a process may be provided for intervening in the valuation resolution process to correct the valuation method being used. This may be done automatically or after human intervention to review the circumstances. For example, clients 110 may agree upon a value resolution method without analysis, or enter a limited set of data to help them determine the value resolution method to be used. Once a method is selected, data for determining actual value may then be entered. During calculations of actual value, results may subsequently indicate that valuation is not occurring based upon predicted results expected by the clients or provider 170 (or other administrator or adviser) or programmed into the valuation process itself. One example of how this may happen is in the mistaken application of a value resolution method particularly designed for a trade secret to value patent 370. Such a corrective feature may be predicated on historical results or indicators that show data or results are not as expected for the identified transaction parameters 380, thereby protecting clients 110 from inaccurate results.

In one more embodiment illustrated by a Step 570, there is the availability for transaction documentation to be generated. Knowing consideration from Step 560 or other method, system or process by which value was determined, plus the appropriate parameters 380 on which the value determination was made, a contract reflecting the terms of the transaction or other document can be competed. This step can be provided automatically or through intervention of the provider 170, the involved clients 110-1, 110-2 or another party. It is contemplated that such a document may be selected from one or more standard documents available on system 100 for such purpose. These document selections can be tailored for the specific purposes arising from different uses of the value resolution system 150, methods and processes. In another embodiment, an automated tool is configured to provide the transaction documents by drawing needed information from system 100 (in particular the value resolution activities). It should be understood that one skilled in the art will be able to provide the capability of an automated tool through, for example, a software program capable of choosing a correct document type and completing data fields in a template to provide a completed version for signature.

In still another embodiment, the standard documentation can be used at the front end of value resolution. For example, when clients 110 enter data for value resolution purposes, the standard documentation can be utilized as the template for, or be populated from, input of data. Such data input may occur, for example, at Steps 460 or 490 or in determining process 410. Where clients 110 have a choice for selecting from among different value methods (as, for example, at Step 460), the standard documentation may be utilized in or involved with picking the valuation method to be used. In such cases, for example, answers to specific queries or the completion of certain data fields may direct the use of certain standard documents and thus a certain value resolution approach associated with them. As previously discussed, the data 400 being referred to may include that intended to define parameters 380 and/or for other purposes, such as pre-determination data for facilitating selection of a value method.

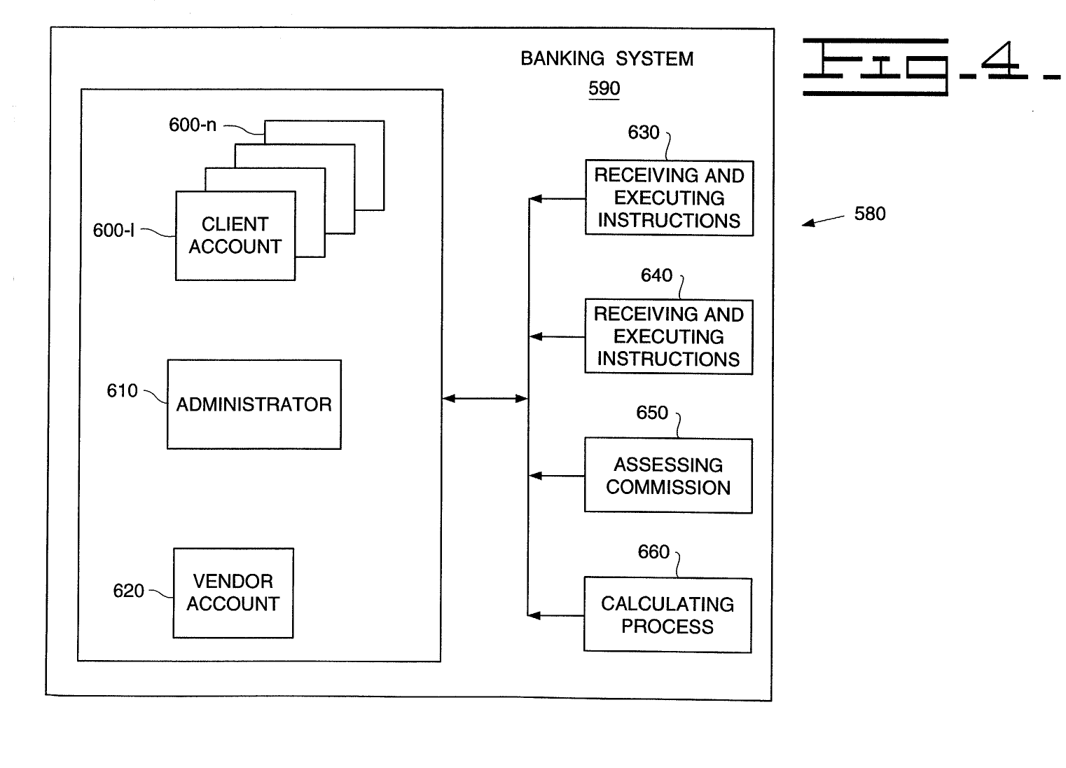

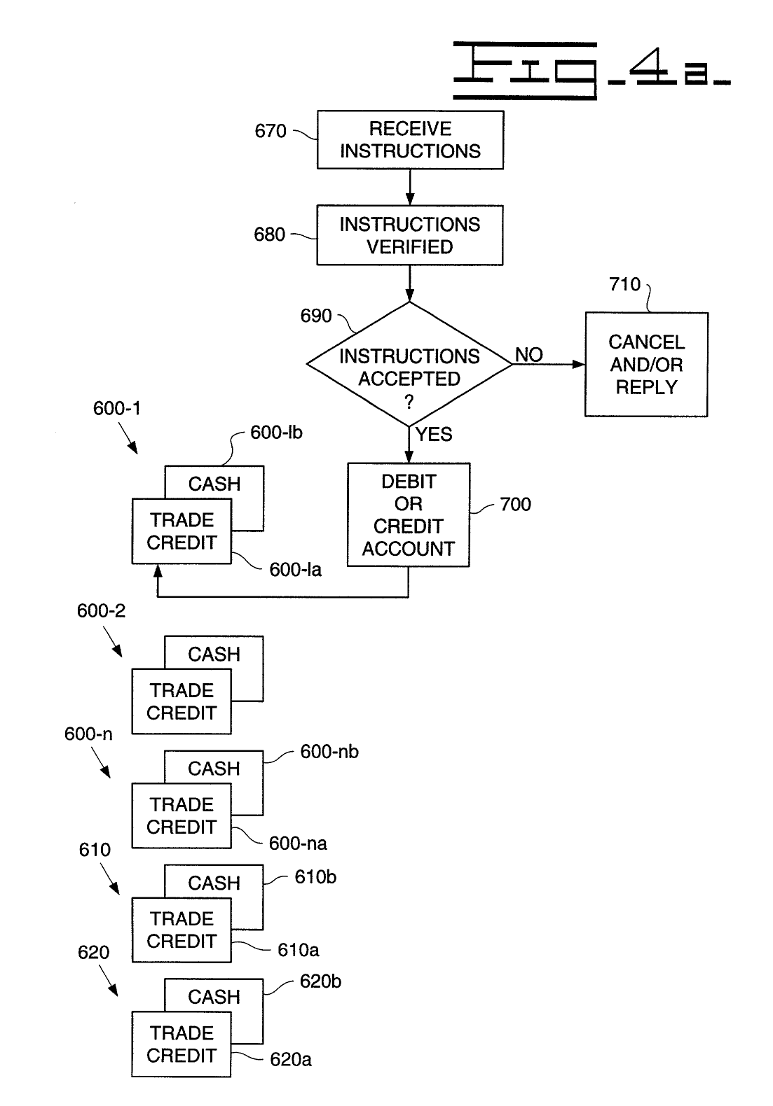

To facilitate transactions in the system 100 in an exemplary embodiment, it is desirable that the consideration be available for future transactions. A client 110 receiving consideration then might apply that consideration to another value resolution issue or for other transactions on property, products or services. Referring to FIG. 4, a bank 580, or bank like system associated with system 100, is available in which each client or member has an account that can be modified to reflect transactions. Most typically, an account may be modified by using entries for debits and credits. In the embodiment illustrated, a banking system 590 has client accounts 600-1 to 600-n and an administrator account 610. The administrator account 610 may belong to provider 170, and there may be similar such accounts for others in an administration function. The client accounts 600-1 to 600-n may also correspond to the client systems 110-1 to 110-n, but do not need to. The banking system 590 may also have vendor accounts 620 (one shown). The administrator and vendor accounts 610, 620 are not essential, but will facilitate the use of the system 100.

The banking system 590 includes first and second processes 630, 640 for receiving and executing instructions for modifying the accounts, such as recording debits and credits in the system 100 currency. In other embodiments, these two processes 630, 640 could be combined. Instructions to modify accounts may be made automatically upon the conclusion of select transactions. Instructions may also be made from clients' systems 110, as well as from the provider 170 or another administrator, and vendor systems 120 for other transactions. For example, upon resolving value by the value resolution system 150, first process 630 receives and executes instructions to indicate the recording of a debit in system currency from the account of one client (for example, a licensee) and a credit to another client (for example, a licensor) as part of the transaction transferring rights in the property 180. The value resolution system 150 might automatically provide the instructions upon establishing consideration, or through approval of one or all involved clients or an administrator.

The second process 640 is for receiving and executing instructions for debit from the account of one system 100 client and a credit to the account of another system 100 client upon a transaction for other available transactions within the system 100. These transactions might include the purchase or license of rights in property 180, products 220 or services 210 listed on the listing system 140 or otherwise through and among vendors, the administrator or clients. While the discussion has centered on clients transacting business through client systems 110, it will be understood that clients, an administrator such as provider 170 and vendors may all enter into any type of transaction. Thus, description of the different systems utilized by each is for convenience of illustrating the different roles that may be played in the market place. Further, the discussion should not be construed to limit access in the manner, or parties to those, described.

Process 650, illustrated in FIG. 4, is provided for assessing a commission for a transaction. This will typically be accomplished by recording a debit in at least one client 600 or vendor 620 account and a credit in the administrator account 610. The process 650 may include a calculating process 660 for calculating the commission. The commission is paid for the services rendered in operating the system 100 and/or providing other services, such as in the context of a transaction or listing. For example, an administrator may receive a percentage of transaction value (such as of a value resolution transaction) or a flat fee.

In one embodiment, the banking system 590 is set to accommodate barter or partly barter based transactions. As such, it accommodates currency that is either legal tender or trade credits or both. The trade credits represent value within the system 100. They will typically have a comparable legal tender value, which is often one for one (for example, US$1 for 1 trade credit).

FIG. 4A shows a flow chart of an exemplary method for bank operation that may be implemented through use of the banking system 590 or by other methods or tools. As shown, the method of banking may begin with input of instructions (Step 670). In the example, clients and others have already set up the accounts (600-1 to 600-n), so they are identified and able to have transactions entered in their accounts based upon instructions. Each account (600-1 to 600-n) is shown as having trade credit and cash sub-accounts (600-1a, 600-1b, respectively). Thus, the accounts (600-1 to 600-n) in this example can receive debits and credits in at least two currencies. Instructions may be received either from the listing process 200 or the value resolution process 150 or from the end steps of the methods illustrated in FIGS. 2A and 3A. Instructions may also be received from or by other processes, methods or systems, as well as other parties authorized to transact business in the bank 580. If an instruction is received from systems 140, 150, it will be appreciated that the instruction may direct activity to two accounts, because of the two party transactions illustrated. Two instructions might also be required, one for each account.

Instructions received should identify the client (and other party as appropriate), typically by name and account number, as well as the amount to be debited or credited. Instructions will further identify the currency or currencies to be debited or credited. Other instructions may also be appropriate. Instructions will be verified at step 680 against account information and other requirements or parameters set by the bank 580. If the instructions are accepted (Step 690 Yes), the appropriate debit or credit will be entered (step 700) in one or more of the accounts (600-1 to 600-n). If instructions are in error, such as an incorrect account number or unauthorized correspondent, the instruction will be cancelled and a reply to the instructor given (Step 710).

As is well known in the art, processes illustrated above with respect to systems 140, 150, 250 may be stored in one or more memory devices and executed by one or more processors running within the systems 140, 150, 250. Alternatively, some or all of these processes may be sub-systems of a respective system 140, 150, 250 that include software, hardware, processing systems, memory, support systems, and any other elements that enable each subsystem to perform their respective functions consistent with features of the present invention. One skilled in the art would realize that the configuration of any one of the systems 140, 150, 250 as shown is exemplary and not intended to be limiting. A number of different processes and configurations may be added and/or removed from the systems 140, 150, 250 without departing form the scope of the present invention. For example, one or all of the processes may be located remotely from, and accessible by, its respective system 140, 150, 250. Additionally, the methods discussed are illustrative of steps that can be followed in carrying out the present invention, including through computer implementation. Systems 140, 150, 250 are exemplary approaches to doing so.

### INDUSTRIAL APPLICABILITY

An example of how system 100 can be applied will now be described. First, an example of value resolution will be discussed, with particular reference to the embodiment of FIG. 3. In this example, it is contemplated that property 180 is the patent 370. The patent 370 is the focus of a dispute between a client owning the patent and a client selling an article. The dispute relates to alleged infringement of the patent 370 by the sale of the article. Quite often, these types of disputes involve substantial exchanges among lawyers about whether there is in fact infringement, whether the patent 370 is valid or enforceable, and the economic value of the issue. Business people also frequently spend considerable time dealing with the issues. The client owning the patent 370 is frequently willing to license its use, but this willingness does not always make resolution any simpler. It will be appreciated that such disputes are complex by their very nature. Patent infringement and validity can be exceedingly difficult issues to resolve. The economic value of the infringement itself is not easily quantifiable, because of the large number of unknowns in dealing with intangible property.

For the present example, it will be assumed that a license to patent 370 is available and that the parties desire to resolve the dispute in a straightforward fashion by agreeing to license terms. The motivation for doing so through the context of the present invention will become apparent. A simplistic valuation methodology will be used to illustrate the invention. It should be understood that the methodologies earlier described (income method, market method, technology factor method) or other appraisal models can be used. Selection will depend upon specific needs of the clients, as well as the ability to automate or otherwise utilize a particular methodology within the steps, processes or other parameters of the value resolution application. The methodology can be applied by human intervention or partly or fully automated.

To illustrate in further detail, pre-selected assigned values are chosen as US$25,000, US$50,000 and US$100,000. The valuation methodology inside which they will be used is further described below. The comparing process 430 will apply in this example, and a maximum actual value of $125,000 is set on a “present value” basis (to be explained below). With reference to FIG. 3A, these activities might occur, for example, at Step 460. It should be noted that the parties may themselves determine the assigned values, as well as the spread of values that they agree to apply to the value resolution (that is, US$0 through US$125,000 in this case). The assigned values and/or maximum value could also be part of one of several value resolution methods or actual value classes available to them for selection or selected in some fashion for them. There might also be a pre-selection process available by which, through answering basic questions or requesting advice of provider 170, particular value resolution aspects are selected.

For this example, the value resolution system 150 will apply a well-known valuation resolution method that uses the concept of division of profits between a licensee and licensor to calculate the value of rights being licensed. This methodology is based upon the premise that use of the licensed patent rights will enable a licensee to generate incremental profits. Because the patent enables the licensee to do this, and the licensee might otherwise need to invest in research and product development to design around the patent, it is reasonable to divide the incremental profit made by the licensee with the patent owner. Historically, it is a common rule of thumb to apportion 25% of the incremental profits to the patent owner. Additionally, an important consideration of value is whether the license rights granted are exclusive or non-exclusive. In this example, we will consider the license to be non-exclusive. Thus, no premium will apply and the 25% profit share will be applicable. Again, the parties may have selected this methodology themselves from the menu (Step 450 in FIG. 3A), agreed to it on their own, or it may be an inherent part of the particular class selected. And the assigned values may be inherent in that selection or chosen by the parties. One may appreciate that such a simple methodology might be apropos for a lower value resolution issue, such as could be considered to be the case for values in the spread of US$0 to US$125,000.

Based upon these parameters, the value resolution system 150 (such as at determining process 410 in FIG. 3) will use the following formula to calculate the profit share to which the client owning the patent (called the licensor) is entitled for a given year:

AVP×P/U×0.25=LPSn

Where:

AVP is the annual volume for a particular product “P” for a particular year “n”.

P/U is the incremental profit per unit in $.

0.25 represents 25% profit share for the Licensor

LPSn is Licensor's Profit Share for Year “n”

For the method of FIG. 3A, Step 520 illustrates where use of such a formula may occur.

In this example, only one product is being considered for license. If the licensee has more than one product, the above formula would be used to determine profit share for each of the additional products in a given year. The Licensor's Profit Share in each year for all products would be a sum of those profit shares for individual products.

The client accused of infringement (proposed licensee) will also produce the product over a number of years, and will need rights under the patent for those years. If it is assumed that the patent has five years left before it expires, and the licensee desires rights for that period, then the licensee will need to provide data for each of the five years remaining. In many licenses, whether to resolve a dispute or not, a licensee will pay the share of profit as it is earned over time (sometimes called ongoing royalties). This will enable the licensee to pay only when it has earned the profit and enable it to pay based upon actual returns instead of estimates for years in the future. However, parties frequently desire to resolve issues by making a single payment in the present.

In this example, it will be assumed that the licensee and licensor desire to resolve their dispute through a single payment in the present, rather than payments over the five years. In this case, then, the determining process 410 will include a step (or sub-process) for calculating the present value of Licensor's Profit Share in each Year “n”. The present values for those years, when added together, represent today's value of those future profit shares. It is well known how to calculate the present value of future cash flows such as for the Licensor's Profit Share over Years n=1 through n=5, using a known interest rate to determine a discount or present value factor. In this example, the interest rate selected in 10%. Discount factors can be calculated to be 0.90909, 0.82645, 0.75131, 0.68301 and 0.62092 for years n=1 through n=5, respectively. These discount factors can be obtained from a variety of sources, including in tables in books on finance.

The determining process 410 can now be used to calculate the actual value of the license to resolve the clients' dispute. The client seeking a license provides the following information about its planned activities over the remaining life of the patent. Planned sales volume is 1000 units each year. Profit per unit is US$60. Applying the formula to calculate the Licensor's Profit Share in year 1 results in the following:

1000 units×US$60×0.25=US$15,000=LPS1

Insofar as each subsequent year has the same anticipated unit volume and profit per unit, Licensor's Profit Share for Years 2 through 4 is also US$15,000.

Actual value is now calculated by the determining process 410 as the sum of the present values of each of Licensor's Profit Share for Years 1 through 5. Present value for Year 1 is calculated as PV=US$15,000×0.90909=US$13,636.35. The present values for Years 2 through 5 are similarly calculated as US$12,396.75, US$11,269.65, US$10,245.15 and US$9,313.80, respectively.

The actual value of the license rights for this exemplary dispute is the sum of the present value for each of the five years or US$56,861.70.

As agreed by the parties, comparing process 430 is utilized to assure that the actual value does not exceed the maximum actual value of US$125,000. The calculated actual value of US$56,861.70 is thus compared to the maximum actual value. This step assures the clients that the actual value is within the range of dispute values that they wish to resolve using the value resolution process 150, namely US$0 through US$125,000. This protects their expectation that the dispute value is within parameters acceptable for resolution by a simple and straightforward valuation methodology, justifying quick resolution without expenditure of significant time and expense discussing the issues. Because the actual value does not exceed the maximum actual value, the value resolution system 150 will continue to process data for resolution of the dispute.

As described, the present example uses an embodiment with assigned values. The assigning process 420 is now used to assign one of the three possible assigned values (US$25,000, US$50,000, US$100,000) to the actual value. In this case, a simple rounding process is used to determine the assigned value. Rounding an actual value of US$56,861.70 to the nearest pre-selected assigned value, yields an assigned value of US$50,000. Other methods of relating the actual value to assigned value can be used. For example, it might be considered to always round an actual value up to the next assigned value or assigned values might be statistically assigned. The assigned value of US$50,000 now represents the economic value of the dispute in legal tender.

Another example for the present value resolution issue will illustrate the use of actual value classes. For example, the parties may be presented with the option of three classes: $0 to $100,000; $100,000 to $250,000; and $250,000 to $500,000. Within the first class, assigned values of $25,000, $50,000 and $100,000 might be set or chosen. In the second class, assigned values of $100,000, $150,000, $200,000 and $250,000 might be set or chosen. In class three, $250,000, $325,000, $400,000 and $500,000 might be set or chosen. The larger spread between assigned values as the classes get higher in value can be used to recognize the differences in tolerance for appraising higher valued properties. It will also be seen that in this example the classes share assigned values at their transition points. This approach moderates the “risk” that a property might be valued just slightly over the maximum value of one class, throwing the resolution into a higher class at a possibly much higher assigned value (or vice versa).

It will be appreciated that for purposes of proceeding with value resolution for patent 370, one of the value classes needs to be selected. One option is for the parties to agree to use any one or more of the classes because the class or classes present a range of values the parties are comfortable resolving through this process. If the parties are agreeable to resolving values that encompass the range of more than one class, then a preliminary assessment or valuation may be applied to determine into which class the value of patent 370 may fall. From there, a valuation is made according to the rules of that class and an assigned value selected. By class rules, it is meant that the valuation methodology, assigned values and/or other characteristics that determine how the class is used for value resolution will be applied. Alternatively, one value methodology may be agreed upon as applicable to any selected class. If that is the case, actual value is calculated and then other characteristics (such as assigned values) of the class are applied.

Assuming the value methodology of the example described is used to determine actual value, then the same actual value will be calculated and value resolution will occur inside the first class ($0 to $100,000). If the same rules also apply as to assigned values, then the same assigned value of $50,000 is chosen. As noted, use of the other classes may call for different valuation methodologies or other elements of valuation resolution as earlier described. But similarly, the parties will appreciate these other class rules in advance and accept them for value resolution if it applies in their situation. Thus, it should be apparent as to how these classes can be applied in value resolution, and no further description will be given.

Prior to considering how the transaction is finally resolved, it is instructive to consider certain advantageous aspects of value resolution for resolving this dispute or any other matter between parties. Parties that negotiate such transactions recognize that valuation aspects of a transaction are impacted by a great deal of things, many of which are outside their control. However, in an effort to resolve matters, it is important to agree on a value and put the matter behind them. Value resolution according to aspects of the present invention can offer straightforward approaches to fit the parties' needs. In embodiments where the systems, methods or processes of the present invention are partly or highly automated, the advantages are anticipated to be even more attractive.

The present invention has the advantage of addressing the expectations of the parties through understood valuation methodologies, assigned values, target values and/or actual value classes. In the case of assigned values, each party recognizes the range of assigned values available, accepts the selection of one for their situation and can plan a dispute budget or other financial matter with that in mind. The assigned values implicitly recognize the variability in the appraisal process. For example, changing the expected sales volume AVP for the present example to a lesser amount of 833 units in one instance and to a greater amount of 1167 units in another instance, yields actual values (on the present value basis) of US$47,400 and US$66,350, respectively. Even with these unit volume changes (each about 17%), the same assigned value of US$50,000 will apply. Thus, both clients to the dispute are protected against some variability, giving them confidence to agree to conclude the matter on the assigned value basis. In some respects, this mimics a real negotiation when the parties must still accept variability given the difficulty of arriving at a precise value. Using the maximum value or actual value classes also protects the clients by preventing use of a value resolution system or method where a property has an unanticipated valuation that would not fit the clients' original expectations.

Thus, the systems, methods and processes of the present invention promote resolution of issues regarding property 180. They provide a way by which parties will more willingly conclude matters. Parties can judge the risk and costs against a known process for resolution. Transaction costs are reduced as parties are less likely to expend money in arguing or negotiating their positions. Even in apparently simple patent infringement or licensing matters, costs can quickly rise well beyond the settlement. It will be appreciated that a particularly apt application for the value resolution system 150 is in matters with relatively small transaction value. These are situations where settlement value can quickly be outweighed by costs. They are also transactions where parties can, in a sense, afford to be “wrong” because the money that might be lost is not that significant in the context of possible costs of disputing the issue and interest in quickly resolving issues.

Use of the banking system 590 further simplifies the transaction costs of value resolution matters. In the present example, the process 440 for establishing consideration will be utilized to take advantage of a banking system 590 that utilizes trade credits as system currency. To do this, the process 440 receives the assigned value and automatically calculates the consideration based upon the predetermined value of trade credits relative to United States dollars. For present purposes, one trade credit is assumed to equal to one United States dollar. Therefore, the process 240 will assign a trade credit value to the dispute of 50,000 trade credits. It should be understood that the process 440 for establishing consideration could also take place in the banking system 590 or as a separate process, so long as an appropriate amount is assigned for purposes of managing the flow of currency in the system 100.

Once the consideration is established, the banking system 590 is instructed to debit the client licensee's account (600-1a) for 50,000 trade credits and to credit the client licensor's account (600-2a) for 50,000 trade credits. This instruction can be automatic or it can rely on approval of the process by the provider 170 or the involved clients. Broadly, the bank 580, with other aspects of the present invention, thus facilitates the opportunity to resolve disputes, license or even trade in properties where value resolution is important within a community of similarly disposed partners. The clients of the community each resolve a single transaction, for example, on an individual to individual basis. They can offset that individual transaction with other transactions they are involved with in the market place or system 100 by drawing on their bank accounts. In effect, they can trade one property for another. In fact, clients may actually trade or cross-license properties 180 by submitting both properties to value resolution. Any difference in actual or assigned value could be accounted for through the bank 580.

The bank 580 further facilitates transactions by eliminating the need to transfer currency at the close of each transaction. This may be particularly advantageous where trade credits are used, because clients need not necessarily transfer legal tender and thus impact their own cash flow or budget. One can readily see that this advantage may be enhanced where relatively small value transactions are involved. The advantage is further enhanced where a community of clients agree in advance to resolve disputes (at least at certain levels) quickly by using value resolution offered in the market place.

It will be appreciated that embodiments illustrated in some respects by the process 440 for establishing consideration and the bank 580 can accommodate a variety of money from different countries. Conversion rates to trade credits can be determined through a variety of mechanisms and automatically applied. One possibility is to associate trade credits with a well known, published rate of exchange that can be accessed by clients worldwide. Clients will then have a ready understanding of the value of their trade credit accounts.

The banking system 590 can also accommodate more than one type of currency as previously described. In particular, it is believed that the efficiency of the market place (particularly value resolution) is enhanced by using a barter or at least partly barter based system 100. Separate accounts for legal tender of one or more countries could also be used. This would enable transactions in a choice of currency based upon the desires of the involved parties It would also allow some flexibility to the provider in taking commissions.

Provider 170, or other administrative participant in the transaction, will typically be entitled to a commission for maintaining and managing system 1100 or enabling other services, such as transactions in products 220, services 210 and property 180. These commissions can be calculated in a variety of ways and may occur at any point in a transaction. Commissions can be collected from client buyers (for example, licensees) or client sellers (for example, licensors, vendors) or any combination in a given transaction. In the present example, after the transaction has been appropriately recorded in the licensee's and licensor's accounts, a commission is debited to the licensor's account. The commission, in the amount of five percent (2500 trade credits), is automatically credited to the provider's account based upon the conclusion of the value resolution transaction. The commission could also be subtracted from the licensor's consideration before any credit is applied to the licensor's account.

Contemplated are a variety of other transactions in the system 100 that are, in the typical case, recorded in the banking system 590. For example, the market place that is established through the network 130 could be used to list a variety of property 180, products 220 and services 210. For example, intangible property, such as patents or technology, can be listed for license. Clients can use the network 130 to search for products 220, services 210 and property 180. They may directly or through the network 130 make a purchase or negotiate the transaction terms or, where appropriate, make use of value resolution. It is contemplated that any such transactions may be recorded in the banking system 590. However, it should be understood that clients could be allowed to opt out of the banking system 590 and arrange for their own exchange of consideration.

Where standard documentation is used (as at Step 570, FIG. 3A), it is believed that the market place will be further enhanced. The standardized terms of such documentation will help further define what the parties can expect from a transaction, just as knowing the assigned values or maximum values. Standard terms will also facilitate the determination of value, because the valuation methods can take into account the scope, risks and costs associated with the terms. As an example, available valuation methods may account for the warranties offered in a standard contract. By the same token, insurance might be an option selectable by the parties (as at Step 470) and priced into a valuation, furthering managing the risk anticipated by parties in using system 100.

An active market place has numerous advantages, and thus the content of the marketplace in terms of products, services and properties is important. As noted above, use of the value resolution system 150 has particular advantages to those who have some frequent need to resolve disputes or other value driven matters. Where trade credits are used, it is important to have opportunities to use those credits. Having other products 220 and services 210 available in the market place will fulfill that role. Having properties 180 listed will also fulfill the role. With an active exchange of properties 180, the concept of valuation will be better understood through the volume and experience. Use of the value resolution system 150, for example, will further contribute to this knowledge. And transactions will more readily occur, further reducing costs and growing the market place. It is anticipated that other parties will desire to join the market place and participate. For properties 180 that are intellectual property, in particular, the system 100 has the potential to open broader markets, bringing potential buyers and sellers from many industries closer together.

Accordingly, the invention is not limited to the above described aspects of the invention, but instead is defined by the appended claims in light of their full scope of equivalents.

What is claimed is:

1. A method for resolving the value of a property, comprising the steps of:
establishing a methodology for valuation;
determining an actual value for the property based upon the valuation methodology;
comparing the actual value for the property to predetermined value increments; and
assigning one of the value increments as the value for the property.

2. The method of claim 1 wherein the step of determining actual value of the property is web based and an interested buyer and seller of rights communicate through the web.

3. The method of claim 1 wherein the step of establishing a methodology for valuation includes steps of:
providing data for at least one parameter associated with the property; and
automatically establishing the valuation methodology from a plurality of choices of valuation methodologies based upon the data for the at least one parameter.

4. The method of claim 1 wherein the step of establishing a methodology for valuation includes steps of:
providing data for at least one parameter associated with the property;
recommending a valuation methodology in response to the data for the at least one parameter; and
receiving a decision to one of accept and reject the recommendation of the valuation methodology.

5. A method for resolving the value of a property, comprising the steps of:
establishing a methodology for valuation;
determining a value for the property based upon the valuation methodology;
comparing the value for the property to a predetermined target value; and
resolving the value of the property according to a determined relationship of the value with the target value.

6. The method of claim 5 wherein the step of establishing a methodology for valuation includes steps of:
providing data for at least one parameter associated with the property; and
automatically establishing the valuation methodology from a plurality of choices of valuation methodologies based upon the data for the at least one parameter.

7. The method of claim 5 wherein the step of establishing a methodology for valuation includes steps of:
providing data for at least one parameter associated with the property;
recommending a valuation methodology in response to the data for the at least one parameter; and
receiving a decision to one of accept and reject the recommendation of the valuation methodology.

8. The method of claim 5 wherein the step of resolving the value of the property where the value has a predetermined relationship with the target value occurs where the value of the property is less than the target value.

9. A method for resolving the value of a property, comprising the steps of:
establishing a methodology for valuation;
providing information;
determining a value for the property from the information and based upon the valuation methodology;
comparing the value for the property to a plurality of classes, each class having a maximum value and minimum value; and
resolving the value of the property based upon the value class for which the actual value of the property lies between the maximum value and minimum value of that value class.

10. The method of claim 9 further including a step of:
setting at least one predetermined value increment in each of the classes to represent assigned value of the property; and wherein the step of resolving value includes the step of:
assigning a value increment for the value of the property, the value increment being associated with the value class selected for resolving value.

11. A method for resolving the value of property, comprising the steps of:
establishing a valuation methodology;
setting predetermined value increments to represent assigned value of the property;
setting a target value;
providing information into the valuation methodology;
determining an actual value for the property from the information and based upon the valuation methodology;
comparing the actual value to the target value;
comparing the actual value of the property to specific value increments dependent upon the relationship of the actual value to the target value; and
assigning one of the value increments to the property based upon a predetermined relationship for assigning value increments.

12. The method of claim 11 further including the steps of:
determining an exchange value based upon the assigned value increment; and
exchanging consideration in the amount of the exchange value for specific rights to the property.

13. The method of claim 11 wherein the step of comparing the determined actual value to the target value includes the steps of:
rejecting the property as a candidate for value resolution if the determined actual value exceeds the target value; and
accepting the property as a candidate for value resolution if the determined actual value is less than the target value.

14. The method of claim 11 wherein the step of establishing a valuation methodology includes the steps of:
establishing a methodology for assessing the property;
providing information into the assessment methodology;
determining an assessment for the property from the information and based upon the assessment methodology; and
recommending a methodology for valuation based upon the assessment.

15. The method of claim 14 wherein the step of determining an assessment for the property includes the step of:
determining a preliminary value for the property; and the step of establishing a valuation methodology further includes the steps of:
comparing the preliminary value to the target value; and
choosing a valuation methodology based upon the relationship of the preliminary value to the target value.

16. The method of claim 15 wherein the step of setting a target value includes the steps of:
setting a plurality of value classes each having a maximum value and a minimum value representing a target value, each value class having an associated valuation methodology;
comparing the preliminary value to the maximum and minimum values of the value classes;
selecting a value class according to which value class has maximum and minimum values between which the preliminary value falls; and the step of establishing a valuation methodology includes the step of identifying a valuation methodology associated with the selected value class.

17. A barter based system for exchanging property rights between members of the system, comprising:
an automated valuation tool configured to determine the actual value of rights in the property of one member in response to input data for pre-selected valuation parameters;
an automated determining tool configured to determine an assigned value associated with the actual value determined by the valuation tool, said assigned value being selected from a plurality of possible assigned values each having actual values exclusive to that assigned value; and
a bank in which each member has an account in which a debit for the account of the one member and a credit for the account of another member is recorded at least in part as trade credits from the determination of the assigned value.

18. The barter based system of claim 17 wherein the debit and credit are recorded in the bank only where a property has an actual value below a certain amount.

19. A barter based system for concluding transactions in property rights between parties, comprising:
an automated valuation tool configured to determine the value of rights in the property of one party in response to input data for pre-selected valuation parameters;
an automated determining tool configured to calculate consideration transferable by another party for the rights in the property in response to determination of the value of rights in the property; and
a bank in which at least one party account is modified to reflect an amount at least partly in trade credits associated with the calculated consideration.

20. The barter based system of claim 19 further including a tool configured to automatically provide transaction documents for the rights in the property.

21. The barter based system of claim 19 further including at least one additional automated valuation tool and a tool configured to select from among automated valuation tools for use in valuing the rights in the property based upon parameters associated with the property.

22. The barter based system of claim 19 further including an automated comparison tool configured to compare the value determined by the automated valuation tool with a pre-selected target value, and wherein the automated determining tool calculates consideration for the rights in the property based upon a specific relationship between the value of rights and the target value.

23. The barter based system of claim 19 further including an automated assigning tool for determining an assigned value associated with the value determined by the automated valuation tool, said assigned value having actual values exclusively associated with said assigned value and wherein the determining tool calculates consideration based upon the assigned value.

24. The barter based system of claim 19 wherein the barter based system includes a tool configured to list at least one of properties, products and services available for available transactions through the system.

25. The barter based system of claim 19 wherein the at least one member account in the bank is automatically recorded bank in response to calculating consideration.

26. The barter based system of claim 19 further including an administrator for facilitating transactions on the system, said administrator receiving a commission based upon a percentage of the consideration.

27. A system for exchanging rights in intangible properties, comprising:
a plurality of client systems operated by clients;
a listing server system including:
a process for listing intangible properties and services and products and providing those listings to the client systems;
a process for receiving indications of interest in rights in particular intangible properties and services and products from the client servers; and
a processor for executing the processes for listing and receiving indications of interest;
a value resolution system including:
a process for receiving data from a client system that pertains to a particular intangible property;
a process for determining an actual value of the particular intangible property based upon the data;
a process for assigning one of a plurality of predetermined assigned values for the particular intangible property based upon the actual value;
a process for establishing a consideration amount for the particular intangible property associated with the assigned value; and
a processor for executing the processes for receiving use based data, determining an actual value, assigning assigned values and assigning a consideration amount; and
a banking system having client accounts and an administrator account including:
a process for receiving and executing instructions for recording the debit of system currency from the account of a client and a credit to another client upon a transaction for rights in intangible property and products and services on the listing server system;
a process for receiving and executing instructions for recording a debit for the account of one client and a credit for the account of another client for consideration determined by the value resolution system;
a process for calculating and assessing a commission for a transaction by recording a debit in a client account and a credit in the administrator account; and
a processor for executing the processes for receiving and executing instructions, recording a debit and credit and calculating and assessing a commission.
